(19) United States
(12) Patent Application Publication
(10) Pub. No.: US 2026/0270877 A1
(43) Pub. Date: Sep. 10, 2026

(54) TERMINAL AND METHOD TO SUPPORT LOW POWER WAKE-UP RADIO IN WIRELESS COMMUNICATION NETWORK SYSTEM

(71) Applicant: Samsung Electronics Co., Ltd., Suwon-si, Gyeonggi-do (KR)

(72) Inventors: Sriganesh RAJENDRAN, Bangalore (IN); Vinay Kumar SHRIVASTAVA, Bangalore (IN)

(21) Appl. No.: 19/164,350

(22) PCT Filed: Apr. 8, 2024
(86) PCT No.: PCT/KR2024/004588

§ 371 Date: Sep. 11, 2025

(30) Foreign Application Priority Data
Apr. 7, 2023 (IN) 202341026191
Mar. 23, 2024 (IN) 202341026191

(51) Int. Cl. H04W 52/02; H04W 68/02

(52) U.S. Cl. CPC H04W 52/0235; H04W 52/0274; H04W 68/02

(57) ABSTRACT

The disclosure relates to a 5G or 6G communication system for supporting a higher data transmission rate. Embodiments herein provide a method and a UE (100) for supporting a LP-WUR (104) in a wireless communication network. The method includes determining whether a LP-WUR (104) configuration is configured by the network apparatus (200) in the wireless communication network system for the LP-WUR (104) of the UE (100) to monitor for a Wake-Up signal (WUS) from the network apparatus (200), when the UE (100) is in the idle state or inactive state and a MR (103) of the UE (100) is moved to an OFF state or a sleep state. Further the method includes receiving the wake-up indication from the network apparatus (200). Furthermore, the method includes transmitting the wake-up indication to the MR (103) of the UE (100) to move the MR (103) from the OFF state of the sleep state to an ON state.

### TECHNICAL FIELD

The proposed embodiments relate to the field of wireless communication network. More particularly present disclosure relates to a method for supporting a low power wake-up Radio (LP-WUR) in a wireless communication network system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In a New Radio (NR) User Equipment (UE), one of the main factors contributing to power drain is the process of monitoring a Physical Downlink Control Channel (PDCCH) and a decoding Downlink Control Information (DCI). Even when the UE is in an IDLE/INACTIVE state, the UE is required to perform certain operations such as receive paging message which involves monitoring of the DCI scrambled with a Paging-Radio Network Temporary Identifier (P-RNTI) during certain paging occasions based on a Discontinuous Reception (DRX) configuration, thus resulting in power drain even in the IDLE/INACTIVE state. 3^{rd} Generation Partnership Project (3GPP) in release 18 is studying the use of a LP-WUR to achieve power saving. The LP-WUR is a separate hardware which is designed to monitor and receive a particular sequence and/or signal while consuming relatively lower power compared to a Main Radio (MR) used to receive signal from the network such as the NR or a Long-term Evolution (LTE) network.

The LP-WUR is used to monitor for a wake-up indication such as a configured Wake Up Signal (WUS) or sequence and the MR can be in OFF state or a Sleep state which consumes less power than when active. When the LP-WUR detects the WUS, the MR is indicated to move to the ON state and perform the required operations. Thus, resulting in lesser power consumption at the UE. However, the introduction of the LP-WUR will have impact to the legacy layer 2 procedures at the UE side. This invention describes the changes to the Layer 2 procedures to support wake-up radio.

### DISCLOSURE OF INVENTION

### Technical Problem

The principal object of the embodiments herein is to provide a method and UE for supporting a LP-WUR in a wireless communication network system.

Another object of the embodiments herein is to provide methods of using the LP-WUR to perform operations in an IDLE/INACTIVE mode such as supporting paging reception and measurement for mobility.

### Solution to Problem

In one aspect, the embodiments herein are achieved by providing a method for supporting a LP-WUR in a wireless communication network system. The method includes detecting, by a UE, that the UE is in an idle state or inactive state and a MR of the UE is moved to an OFF state or a sleep state. Further, the method includes determining, by the UE, whether a LP-WUR configuration is configured by a network apparatus in the wireless communication network system for the LP-WUR of the UE to monitor for a wake-up indication from the network apparatus, when the UE is in the idle state or inactive state. Further, the method includes receiving, by the UE, a wake-up indication from the network apparatus. Furthermore, the method includes indicating, by the UE, the wake-up indication to the MR of the UE to move the MR from the OFF state or the sleep state to an ON state.

In an embodiment, the method includes performing, by the UE, a downlink synchronization based on an available synchronization signal block or a broadcasted reference signal, when the MR is in the ON state. Further, the method includes receiving, by the UE, a paging message from the network apparatus. Furthermore, the method includes determining, by the UE, whether the paging message comprises an identifier of the UE. Also, the method includes initiating, by the UE, a connection establishment or resumption with the network apparatus. Further includes performing, by the UE, a downlink synchronization base on available synchronization signal block or a broadcasted reference signal, when the MR is in the ON state. Also, the method includes determining, by the UE, whether the received wake-up indication is a UE specific wake-up indication. Further, the method includes initiating, by the UE, a connection establishment or resumption with the network apparatus, when the received wake-up indication is the UE specific wake up indication.

In an embodiment, the method includes performing, by the UE, a downlink synchronization based on available synchronization signal block or a broadcasted reference signal, when the MR is in the ON state. Further, the method includes determining, by the UE, whether a Paging Early Indication (PEI) is configured by the network apparatus to the UE. Further, the method includes receiving, by the UE, the PEI from the network apparatus. Also, the method includes determining, by the UE, whether the PEI addresses a group which the UE belongs to. Furthermore, the method includes receiving, by the UE, a paging message from the network apparatus. Also, the method includes determining, by the UE, whether the paging message comprises an identifier of the UE and initiating, by the UE, a connection establishment or resumption with the network apparatus.

In an embodiment, the method includes performing, by the UE, a downlink synchronization based on available synchronization signal block or a broadcasted reference signal, when the MR is in the ON state. Further, the method includes starting, by the UE, a false alarm timer. Further, the method includes monitoring, by the UE, a paging message from the network apparatus. Also, the method includes, increasing, by the UE, a count of the false alarm timer when no paging is received till an expiry of the false alarm timer. Further, the method includes triggering, by the UE, the MR move from the ON state to the OFF state or sleep state upon expiry of false alarm timer and triggering, by the UE, the LP-WUR to monitor for the wake-up indication from the network apparatus.

In an embodiment, the method includes performing, by the UE, a downlink synchronization based on available synchronization signal block or a broadcasted reference signal, when the MR is in the ON state. Further, the method includes starting, by the UE, a false alarm timer. Also, the method includes monitoring, by the UE, a paging message from the network apparatus. Further, the method includes increasing, by the UE, a count of a false alarm timer when no paging is received till an expiry of the false alarm timer. Furthermore, the method includes determining, by the UE, whether the count of the false alarm timer meets a configured maximum false alarm detection threshold. Further, the method includes releasing, by the UE, the LP-WUR configuration when the count of the false alarm timer meets a maximum false alarm detection threshold. Also, the method includes initiating, by the UE, a connection establishment or resumption with the network apparatus. Further, the method includes reporting, by the UE, the release of LP-WUR configuration to the network apparatus and receiving, by the UE, a new LP-WUR configuration from the network apparatus.

In an embodiment, the method includes detecting, by the UE, a list of cell identities, and a list of area identities where a configured LP-WUR parameters is valid. The list of cell identities, and the list of area identities is configured by the network apparatus. Further, the method includes receiving, by the UE, at least one of a cell identity and an area identity transmitted by the network apparatus as part of at least one of a Low Power Synchronization Signal (LP-SS) and the wake-up indication. Also, the method includes determining, by the UE, whether at least one of the received cell identities and the received area identity is part of the configured list of valid cell identities and the configured list of area identities. Further, the method includes indicating, by the LP-WUR of the UE, to the MR of the UE, to perform cell selection or reselection process, when at least one of the received cell identities and the received area identity is not part of at least one of the configured valid cell ID list and area identity list and releasing, by the UE, the stored LP-WUR configuration.

In another aspect, the embodiment herein provide a UE for supporting the LP-WUR in the wireless communication network system. The UE includes a memory comprising information of a network apparatus in the wireless communication network system, a processor, a MR, and a LP-WUR support controller. The LP-WUR support controller detects that the UE is in an idle state or inactive state and the MR of the UE is moved to an OFF state or a sleep state. Further the LP-WUR support controller receives determine whether a LP-WUR configuration is configured by the network apparatus in the wireless communication network system for the LP-WUR of the UE to monitor for a wake-up indication from the network apparatus, when the UE is in the idle state or inactive state. Further, the LP-WUR support controller receives the wake-up indication from the network apparatus. Furthermore, the LP-WUR support controller transmits the wake-up indication to the MR of the UE to move the MR from the OFF state of the sleep state to the ON state.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### Advantageous Effects of Invention

According to an embodiment of present disclosure, a terminal can efficiently perform a communication.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 illustrates a block diagram of a UE for providing a method for supporting a LP-WUR in a wireless communication network system, according to the embodiments disclosed herein;

FIG. 2 illustrates a flow chart that illustrates a method for supporting the LP-WUR in the wireless communication network system, according to the embodiments disclosed herein;

FIG. 3 illustrates a sequence diagram that illustrates a scenario in which the reception of wake-up indication triggers the monitoring of paging message immediately by MR and in the next valid Paging occasion by the MR, according to the embodiments as disclosed herein;

FIG. 4 illustrates a sequence diagram that illustrates a scenario in which the reception of wake-up indication triggers the connection establishment to the network by the MR without monitoring of paging message, according to the embodiments as disclosed herein;

FIG. 5 illustrates a sequence diagram that illustrates a scenario in which the detected wake-up indication is a false alarm. It depicts the detection of the false alarm by the MR, according to the embodiments as disclosed herein; and

FIG. 6 illustrates a sequence diagram that illustrates a scenario in which the detected WUS is the false alarm and releases the LP-WUR configuration when number of detected false alarm exceeds the configured threshold, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, the embodiments disclose method for supporting a LP-WUR in a wireless communication network system. The method includes transmit the wake-up indication to a MR of the UE to move the MR from the OFF state of the sleep state to the ON state. Further, the method includes determining, by the UE, whether a LP-WUR configuration is configured by a network apparatus in the wireless communication network system for the LP-WUR of the UE to monitor for a wake-up indication from the network apparatus, when the UE is in the idle state or inactive state. Further, the method includes receiving, by the UE, a wake-up indication from the network apparatus. Furthermore, the method indicating, by the UE, the wake-up indication to the MR of the UE to move the MR from the OFF state or the sleep state to an ON state.

Accordingly, the embodiment herein is to provide a UE for supporting a LP-WUR in a wireless communication network system. The UE comprises a memory comprising information of a network apparatus in the wireless communication network system, a processor, a MR, and a LP-WUR support controller. The LP-WUR support controller detects that the UE is in an idle state or inactive state and the MR of the UE is moved to an OFF state or a sleep state. Further the LP-WUR support controller receives determine whether a LP-WUR configuration is configured by the network apparatus in the wireless communication network system for the LP-WUR of the UE to monitor for a wake-up indication from the network apparatus, when the UE is in the idle state or inactive state. Further, the LP-WUR support controller receives the wake-up indication from the network apparatus. Furthermore, the LP-WUR support controller transmits the wake-up indication to the MR of the UE to move the MR from the OFF state of the sleep state to the ON state.

In the present situation, when the UE is in an IDLE or INACTIVE state, it is necessary to carry out certain operations. These include receiving a paging message, which entails monitoring a DCI that is scrambled using a Paging-Radio Network Temporary Identifier (P-RNTI) during specific paging occasions. This is based on a Discontinuous Reception (DRX) configuration, resulting in power depletion even when the UE is in an IDLE or INACTIVE state. Power drainage is therefore a significant concern. Furthermore, there is currently no specification in place to support LP-WUR in the 5G system. As such, this invention presents solutions to support LP-WUS in the 5G system.

The present solution offers an elegant approach, comprising a method and UE, to manage Low Power Wake Up Radio in a wireless communication network system. This innovative solution leverages the low power wake up radio technology to implement the operations in the IDLE/INACTIVE mode, including aiding in paging reception and facilitating mobility measurements.

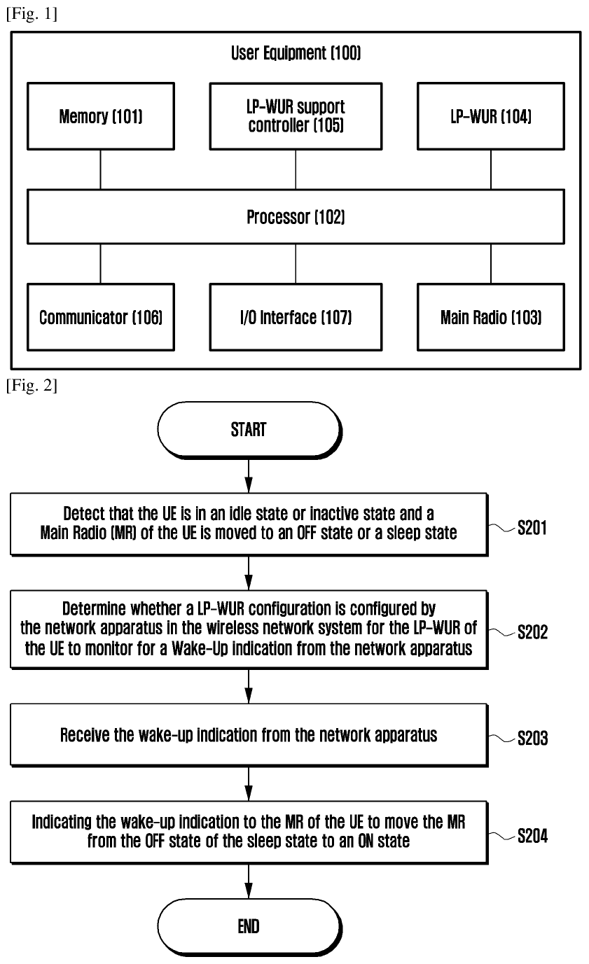

FIG. 1 illustrates a block diagram of the UE (100) for providing a method for supporting the LP-WUR (104) in a wireless communication network system, according to embodiments as disclosed herein. The UE (100) includes a processor (102), a memory (101), an I/O interface (107), a LP-WUR support controller (105), a LP-WUR (104), a communicator (106) and a MR (103).

In an embodiment, the UE (100) acts as an end-user device is capable of connecting to the wireless communication network system for the purpose of accessing services. This device can take various forms, including but not limited to a mobile phone, a smart phone, tablets, laptops, and Internet of Things (IoT) devices. Essentially, any device that can connect to the wireless communication network system and access services can be considered a UE (100).

Further, the processor (102) communicates with the memory (101), the I/O interface (107), the LP-WUR support controller (105), the LP-WUR (104), the communicator (106) and the MR (103). The processor (102) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU). Further, the memory (101) of the UE (100) includes storage locations to be addressable through the processor (102). The memory (101) is not limited to a volatile memory (101) and/or a non-volatile memory (101). Further, the memory (101) can include one or more computer-readable storage media. The memory (101) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories.

The I/O interface (107) serves as the intermediary for transmitting information between the memory (101) and external peripheral devices, which are the input-output devices associated with the UE (100). This interface (107) not only receives multiple information from the network, but also possesses additional resources such as voltage translators, registers, impedances, and buffers. For instance, input devices such as a keyboard and mouse provide data to the computer, while output devices such as a monitor and printer display and print information respectively.

In an embodiment, the LP-WUR support controller (105) is an innovative hardware that is implemented through the physical implementation of both analog and digital circuits, including logic gates, integrated circuits, microprocessors, microcontrollers, memory circuits, passive and active electronic components, as well as optical components.

In an embodiment, the LP-WUR support controller (105) is connected to the memory (101) and the processor (102). The LP-WUR support controller (105) detects that the UE (100) is in an idle state or inactive state and the MR (103) of the UE (100) is moved to an OFF state or a sleep state. Further the LP-WUR support controller (105) determines whether the LP-WUR (104) configuration is configured by the network apparatus in the wireless communication network system for the LP-WUR (104) of the UE (100) to monitor for the Wake-up indication from the network apparatus, when the UE (100) is in the idle state or inactive state. Further LP-WUR support controller (105) receives the wake-up indication from the network apparatus and transmit the wake-up indication to the MR (103) of the UE (100) to move the MR (103) from the OFF state of the sleep state to an ON state.

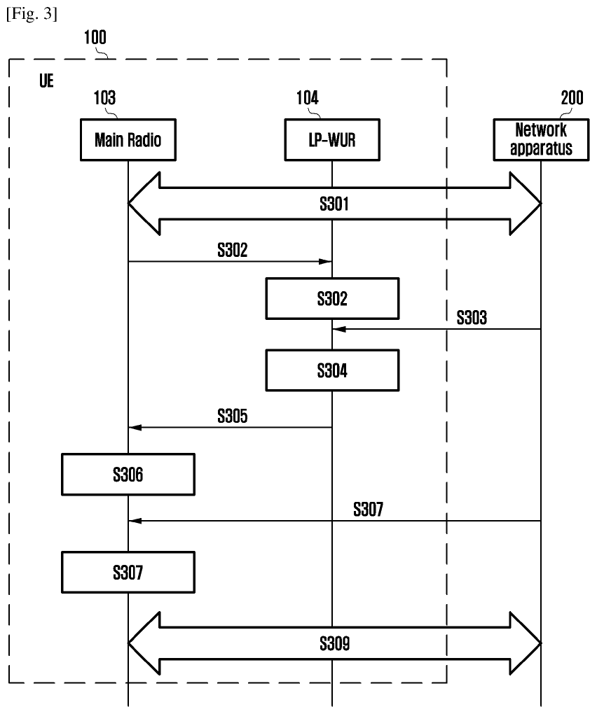

FIG. 2 illustrates a flow chart that illustrates a method for supporting the low power wake-up Radio in the wireless communication network system, according to the embodiments disclosed herein.

At S201, the method includes detecting, by the UE (100), that the UE (100) is in an idle state or inactive state and the MR (103) of the UE (100) is moved to an OFF state or a sleep state.

At S202, the method includes determining, by the UE (100), whether the LP-WUR (104) configuration is configured by the network apparatus (200) in the wireless communication network system for the LP-WUR (104) of the UE (100) to monitor for a Wake-Up indication from the network apparatus, when the UE (100) is in the idle state or inactive state.

Further, at S203, the method includes receiving, by the UE (100), the wake-up indication from the network apparatus. Furthermore, at S204, the method includes indicating, by the UE (100), the wake-up indication to the MR (103) of the UE (100) to move the MR (103) from the OFF state of the sleep state to an ON state.

FIG. 3 is a sequence diagram that illustrates a scenario in which the reception of wake-up indication triggers the monitoring of paging message immediately by MR (103) and in the next valid Paging occasion by the MR (103), according to the embodiments as disclosed herein.

At step S301, the LP-WUR (104) is configured via an RRC message SIB message towards the network apparatus (200). The MR (103) is configured to monitor for wake-up indications at step S302. At step S302, the LP-WUR (104) monitors for wake-up indications. Upon receiving a wake-up indication from the network apparatus (200) at step S303, the LP-WUR (104) notifies the MR (103) whether the wake-up indication is for the UE (100) at step S304. At step S305, the wake-up indication is then sent to the MR (103). Upon receiving the wake-up indication, the MR (103) starts monitoring for the paging message and begins receiving the paging message in the next valid paging occasion, after acquiring synchronization with the network. At step S307, the MR (103) receives the paging message from the network apparatus. The MR (103) then determines whether the paging message contains the UE ID and establishes an immediate connection at step S308. Further, at step S309, the MR (103) initiates the connection establishment/resumption with the network apparatus (200).

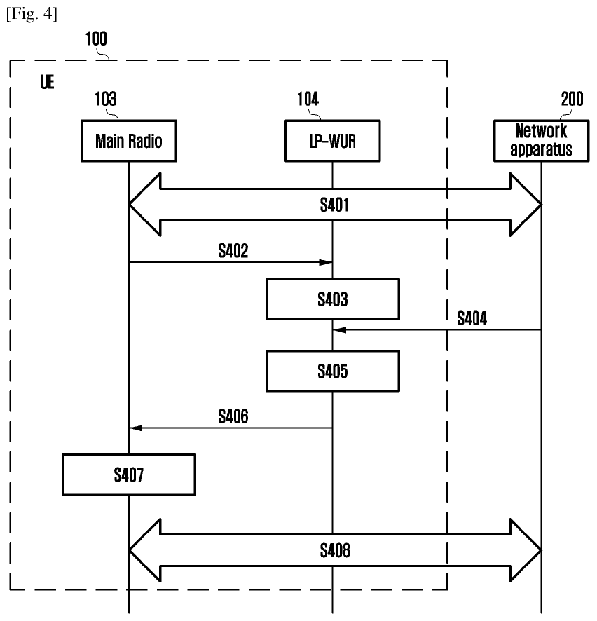

FIG. 4 is a sequence diagram that illustrates a scenario in which the reception of wake-up indication triggers the connection establishment to the network by the MR (103) without monitoring of paging message, according to the embodiments as disclosed herein.

At step S401, the LP-WUR (104) is configured by the network apparatus (200) through RRC message SIB message. At step S402, the MR (103) is configured to monitor for wake-up indications. At step S403, the LP-WUR (104) monitors for wake-up indications. At step S404, the LP-WUR (104) receives a wake-up indication. Upon receiving the wake-up indication at step S405, the LP-WUR (104) notifies the MR (103) whether it is intended for this particular UE (100). At step S406, the wake-up indication is sent to the MR (103). Upon receiving the wake-up indication at step S407, the MR (103) performs synchronization and initiates connection establishment/resumption. Further, at step S408, the UE (100) initiates a connection establishment or resumption with the network apparatus (200).

In an embodiment, the UE (100) is configured with multiple IDs and/or wake up signals/sequences to indicate different notifications from the network.

In an embodiment, the LP-WUR (104) receives the Cell ID and or an Area ID as part of the periodic synchronization and/or beacon signal and/or the wake-up indication. The UE (100) is configured with the Cell ID and/or a list of Cell IDs and/or the area ID within which the received wake up signaling configuration is valid.

In an embodiment, the UE (100) detects a list of cell identities, and a list of area identities where a configured LP-WUR parameters is valid. The list of cell identities, and the list of area identities is configured by the network apparatus (200). Further, the UE (100) receives a cell identity and/or an area identity transmitted by the network apparatus (200) as part of at least one of a LP-SS and the wake-up indication. Further, the UE (100) determines whether at least one of the received cell identities and the received area identity is part of the configured list of valid cell identities and the configured list of area identities. The LP-WUR (104) of the UE (100) indicates to the MR (103) of the UE (100), to perform cell selection or reselection process, when at least one of the received cell identities and the received area identity is not part of at least one of the configured valid cell ID list and area identity list. Further, releasing the stored LP-WUR configuration by the UE (100).

In an embodiment, the behaviour of the UE (100) upon reception of the wake up indication by the LP-WUR (104) is configured by the network apparatus (200). The network apparatus (200) configures the UE (100) to perform one of:
receive the paging message in the next valid paging occasion
receive the paging message immediately
initiate the connection request/resume procedure immediately

The network apparatus (200) configures behaviour of the UE (100) based on one of
UE's indicated preference as part of UE assistance information and/or
UE's capability to imitate the connection request/resume after the WUS indicated via UE capability information
latency requirements of the service UE is subscribed or receiving.

In an embodiment, the UE (100) is configured with multiple IDs and/or wake up signals/sequences to indicate different notifications from the network apparatus (100). In an embodiment, the UE (100) is configured with at least one of or combination of
the wake up signal and/or ID to indicate the UE (100) to receive the paging message immediately
the wake up signal and/or ID to indicate the UE (100) to receive the paging message in the next valid paging occasion
the wake up signal and/or ID to indicate the system information change notification. Upon reception of the WUS, the UE (100) initiates the SI acquisition procedure
the wake up signal and/or ID to indicate the UE (100) to indicate public warning service notifications such as Earthquake and Tsunami Warning System (ETWS)/Commercial Mobile Alert System (CMAS), upon reception of which the UE (100) initiate the acquisition of ETWS/CMAS related system information block
the wake up signal and/or ID to indicate the UE (100) to indicate multicast/broadcast session activation/deactivation/change.

In an embodiment, the UE is configured with a threshold of maximum number of times the LP-WUR can fail to detect the beacon signal and/or the synch signal in consecutive sync/beacon signal occasions. In an embodiment, upon reaching the threshold, the LP-WUR indicates the MR to perform cell (re)selection procedure. The stored LP-WUR configuration is released.

In an embodiment, the UE is configured with a timer Txxx, which is started when the LP-WUR does not receive the Synch/Beacon signal is not received during the Sync/beacon signal monitoring occasion. When the LP-WUR does not receive the Sync/beacon signal before the expiry of the timer, the LP-WUR indicates to the MR to perform cell (re)selection procedure and to release the stored LP-WUR configuration. The timer Txxx is stopped/reset upon reception of the Sync/Beacon signal.

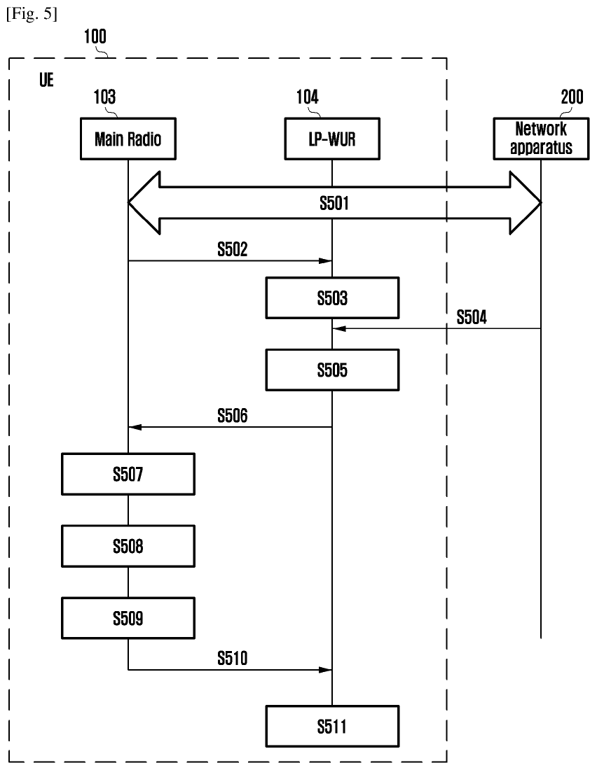

FIG. 5 is a sequence diagram that illustrates a scenario in which the detected wake-up indication is a false alarm. It depicts the detection of the false alarm by the MR (103), according to the embodiments as disclosed herein

At step S501, the LP-WUR (104) configures through RRC message SIB message toward network apparatus (200). At step S502, the MR (103) configures to monitor for the wake-up indication. At step S503, the LP-WUR (104) monitor for the wake-up indication and at step S504, the wake-up indication is received by the LP-WUR (104). At step S505, the LP-WUR (104) receive the wake-up indication and notifies the MR (103) whether the wake-up indication is for this particular UE (100). At step S506, the wake-up indication sends to the MR (103). At step S507, the MR (103) performs a downlink synchronization based on available synchronization signal block or a broadcasted reference signal, when the MR (103) is in the ON state and a false timer started where a paging message from the network apparatus (200). At step 508, the UE (100) increases a count of the false alarm timer when no paging is received till an expiry of the false alarm timer. At step S509, the UE (100) triggers the MR (103) move from the ON state to the OFF state or sleep state upon expiry of false alarm timer. At step S510, the UE (100) triggers the LP-WUR (104) to monitor for the wake-up indication from the network apparatus (200). At step S511, the LP-WUR (104) monitor for the wake-up indication.

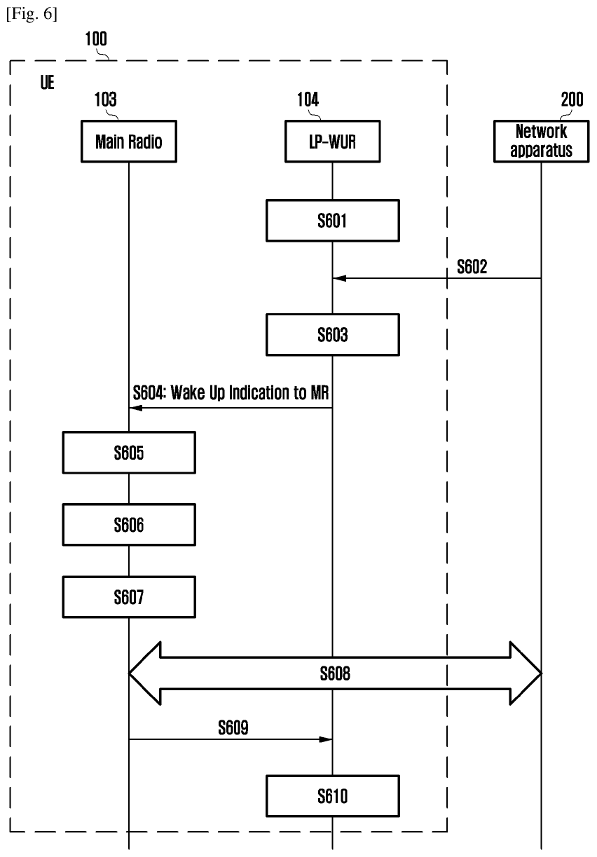

FIG. 6 is a sequence diagram that illustrates a scenario in which the detected wake-up indication is the false alarm and releases the LP-WUR (104) configuration when number of detected false alarm exceeds the configured threshold, according to the embodiments as disclosed herein.

At step S601, the LP-WUR (104) monitor for the wake-up indication. At step S602, the wake-up indication is sent by the network apparatus (200) to the LP-WUR (104). At step S603, the LP-WUR (104) on receiving wake-up indication from the network apparatus (200), notify the MR (103) the wake-up indication is for this particular UE (100) or not. At step S604, the wake-up indication is received by the MR (103). At step S605, the MR (103) perform a downlink synchronization based on available synchronization signal block or a broadcasted reference signal, when the MR (103) is in the ON state and start the false alarm timer, also monitor a paging message from the network apparatus (200). At step S606, the UE (100) increases a count of a false alarm timer when no paging is received till an expiry of the false alarm timer. At step S607, the UE (100) increases whether the count of the false alarm timer meets a configured maximum false alarm detection threshold. Further, the UE (100) releases the LP-WUR (104) configuration when the count of the false alarm timer meets a maximum false alarm detection threshold and reporting to the network apparatus (202). At step S608, the UE (100) initiates a connection establishment or resumption with the network apparatus (200). Further, the UE (100) initiates a connection establishment or resumption with the network apparatus (200). The UE (100) receives a new LP-WUR configuration from the network apparatus (200). At step S609, the MR (103) configure the LP-WUR (104) to monitor for the wake-up indication. At step S610, the LP-WUR (104) monitors for the wake-up indication.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a terminal in a wireless communication system, the method comprising:
receiving, from a base station by a low power-wake up receiver (LP-WUR), a wake up indication;
delivering, from the LP-WUR to a main radio (MR), an indication to monitor a paging; and
monitoring, by the MR, the paging.

2. The method of claim 1, further comprising:
monitoring, by the MR, for a paging early indication (PEI) for receiving the paging.

3. The method of claim 1, wherein receiving further comprising:
receiving, by the MR, the paging in a next valid paging occasion.

4. The method of claim 1, wherein receiving further comprising:
receiving, by the MR, the paging immediately.

5. The method of claim 1, wherein the wake up indication further includes at least one of a cell identity (ID), or an area ID.

6. The method of claim 1, further comprising:
receiving, by the LP-WUR, a LP synchronization signal (SS).

7. The method of claim 1, wherein the MR is triggered to move from an OFF state to an ON state by the LP-WUR, in case that the wake up indication is received by the LP-WUR.

8. A terminal in a wireless communication system, the terminal comprising:
a low power-wake up receiver (LP-WUR) configured to receive a wake up indication from a base station, and
a main radio (MR) configured to be delivered from the LP-WUR an indication to monitor a paging, and monitor the paging.

9. The terminal of claim 8, wherein the MR is further configured to:
monitor for a paging early indication (PEI) for receiving the paging.

10. The terminal of claim 8, wherein the MR is further configured to:
receive the paging in a next valid paging occasion.

11. The terminal of claim 8, wherein the MR is further configured to:
receive the paging immediately.

12. The terminal of claim 8, wherein the wake up indication further includes at least one of a cell identity (ID), or an area ID.

13. The terminal of claim 8, wherein the LP-WUR is further configured to:
receive a LP synchronization signal (SS).

14. The terminal of claim 8, wherein the MR is triggered to move from an OFF state to an ON state by the LP-WUR, in case that the wake up indication is received by the LP-WUR.
